(19) United States
(12) Patent Application Publication
(10) Pub. No.: US 2008/0099097 A1
(43) Pub. Date: May 1, 2008

(54) METHOD OF DETERMINING THE GAS RETURN RATE OF FILLING PUMPS

(75) Inventors: Chistian Maurer, Hamburg (DE); Wolfgang Schrittenlacher, Hamburg (DE); Stefan Kunter, Hamburg (DE)

Correspondence Address: HOVEY WILLIAMS LLP, 10801 Mastin Blvd., Suite 1000, Overland Park, KS, 66210, US

(73) Assignee: FAFNIR GMBH, Hamburg (DE)

(21) Appl. No.: 11/689,260

(22) Filed: Mar. 21, 2007

(30) Foreign Application Priority Data
Oct. 26, 2006 (DE) 10 2006 050 634.0

(51) Int. Cl. B67C 3/00

(52) U.S. Cl. 141/18

(57) ABSTRACT

A method of determining the gas return rate at filling stations is carried out at filling pumps with two filling points, a first filling point and a second filling point. Each filling point is assigned at least one fuel flow meter of its own and both filling points are assigned a common gas flow meter, which is arranged downstream of a meeting point of the gas streams of the two filling points. The measured values obtained from the two fuel flow meters and from the gas flow meter are recorded at short predetermined time intervals in assignment to one another. In the case of at least partially simultaneous refuelling operations at the two filling points, the information determined from the measured values of the fuel flow meters concerning the progression over time of the two refuelling operations is used for breaking down the measured sum of the gas flow of the two filling points into a gas flow assigned to the first filling point and a gas flow assigned to the second filling point.

### RELATED APPLICATION

This Application claims priority of German Application Serial No. 10 2006 050 634.0, filed Oct. 26, 2006, which is hereby incorporated by reference herein.

### BACKGROUND OF THE INVENTION

1. Field of the Invention

The invention relates to a method of determining the gas return rate at filling pumps with two filling points (each for carburettor fuels), each filling point being assigned one (or more) fuel flow meters and both filling points being assigned a common gas flow meter.

2. Discussion of Prior Art

Gas return systems at filling stations have been mandatory in some European countries since the beginning of the nineties. With a gas return system, the fuel vapours that are displaced when filling the tank of a motor vehicle with fuel during refuelling of the vehicle are extracted by means of a gas pump and returned to the storage tank of the filling station. In this case, the volumetric flow of fuel (fuel flow) and the volumetric flow of gas (gas flow), i.e. the volumes of fuel and gas (vapours) delivered per unit of time, should be equal. The terms gas return rate, gas flow and volumetric flow of gas are used synonymously here.

With the conventional technique of gas return, the volumetric flow of gas delivered by a gas pump is set either by a speed control of the drive motor of the gas pump or by a throttle valve. The parameters governing how this setting of the volumetric flow of gas has to be performed for the different volumetric flows of fuel are stored in the operating electronics of the gas return system (calibration data). To determine these parameters, an operation of adjusting the gas return is carried out by connecting a flow meter (generally a positive displacement meter) to the gas exhauster of a filling nozzle, the measured flow values of which meter can be respectively assigned to the setting parameter. This assignment is stored in the operating electronics of the gas return system and makes it possible to set the gas return in the subsequent refuelling operation—after removal of the positive displacement meter—in such a way that the volumetric flow of gas corresponds to the volumetric flow of fuel.

Because of the errors that occur in gas return and generally remain undetected, additional gas return monitoring systems have been prescribed. These have been in widespread use since 2003 and have brought about a significant improvement in the state of gas return.

The previous technique monitored the gas return for each filling point with a gas flow meter (flow sensor) for each, so that, when there are deviations between the measured values obtained from the gas flow meter and the measured values obtained from the fuel flow meter of the filling point, a possible malfunction of the gas return is detected for the filling point concerned. Such a malfunction must then be signaled. This is performed by the transmission of a signal to a higher-level system, for example the filling-pump computer, which transmits this information to the cash-desk computer of a filling station, where it is visually displayed to the operating personnel. In the event that the malfunction has not been rectified for a defined period of time, a switch-off signal is generated by the gas return monitor, which switches off the filling point concerned, so that refuelling is no longer possible there.

An enhancement of this configuration can considerably increase the operational reliability of the gas return. This is achieved by a corrective control (DE 103 37 800 A1), in which the gas return can be corrected within certain limits in such a way as to compensate for any instances of degradation. This avoids unnecessary triggering of an alarm and extends the times between services.

A filling pump of a filling station generally has two filling points, so that two gas flow meters are used in the filling pump.

In the case of filling pumps with two filling points, it is possible to refuel on both sides. However, simultaneous refuelling operations do not occur very often. To this extent, it is attractive to reduce the number of flow sensors and to monitor the gas return in the filling pump only with a single flow sensor. Such a method is described in U.S. Pat. No. 6,622,757, U.S. Pat. No. 6,880,585 and U.S. Pat. No. 6,968,868, even disclosing a reduction to only one flow sensor for an entire filling station. In this case, all the volumes of fuel that are delivered in refuelling operations within a specific period of time and for which gas flows are assigned to a flow sensor are registered and the entire returned gas volume is determined. This operation is repeated as often as filling points encounter a gas flow sensor. This produces a uniquely solvable system of linear equations, so that each filling point can be assigned a return ratio of the volumes (volume of gas/volume of fuel).

However, this method has disadvantages.

This is so because, in refuelling operations with different flows (i.e. amounts delivered per unit of time), the return ratio may differ. This occurs relatively frequently in practice. In this case, only a mean value would be determined for the filling point, and the actual cause of an error in the event of deviations cannot be detected.

Furthermore, the regulations of several European countries state that the gas return is verified with the aid of a return rate ratio (gas return rate/fuel delivery rate, i.e. the volume of gas returned per unit of time/the volume of fuel delivered per unit of time). This is not possible by the known technique with a reduced number of flow sensors, since only volumes and not volume rates (volumes per unit of time) can be compared.

The regulations of several European countries also prescribe that, in refuelling operations that satisfy specific criteria with respect to a minimum fuel flow and a specific minimum refuelling time, the gas return rates must be individually assessed. In the case of these refuelling operations to be assessed, it must then be checked whether they are within a specific predetermined tolerance band. If this is not the case for a series of refuelling operations, an alarm must be triggered. This is likewise not possible by the known technique with a reduced number of flow sensors, since it is necessary to wait for a relatively long series of refuelling operations to achieve a solution for the system of equations.

### SUMMARY AND OBJECTS OF THE INVENTION

The object of the invention is therefore to provide a method of determining the gas return rate at filling stations that manages with a reduced number of gas flow meters (in particular with only one gas flow meter per filling pump), and that makes it possible nevertheless to assess each individual refuelling operation near the time it occurs and to determine the gas return rate, and consequently the return rate ratio, even if these refuelling operations are performed at overlapping times.

This object is achieved by a method with the features of Claim 1. Advantageous refinements of the invention emerge from the subclaims. Claim 13 relates to a device for carrying out the method.

The method according to the invention is designed for determining the gas return rate at filling pumps with two filling points (a first filling point and a second filling point), each filling point being assigned a fuel flow meter of its own (or else a number of fuel flow meters if a number of grades of carburettor fuel are available at the filling point) and both filling points being assigned a common gas flow meter. This gas flow meter is arranged downstream of a meeting point of the gas streams of the two filling points. In this case, the measured values obtained from the fuel flow meters of the two filling points and from the gas flow meter (in the form of measuring signals or after electronic preparation) are recorded at short predetermined time intervals in assignment to one another. Short time intervals are understood here as meaning time intervals that are small in comparison with the duration of a typical refuelling operation, so that the measured values for the refuelling operations can for example be presented graphically as a function of time with adequate temporal resolution. In the case of at least partially simultaneous refuelling operations at the two filling points (i.e. refuelling operations overlapping in time), the information determined from the measured values of the fuel flow meters concerning the progression over time of the two refuelling operations is used for breaking down the measured sum of the gas flow of the two filling points into a gas flow assigned to the first filling point and a gas flow assigned to the second filling point.

If the progression over time of the fuel flow and of the assigned gas flow in a refuelling operation at a filling point is generally box-shaped (for example box-shaped with steep leading and trailing edges, as is generally the case in normal refuelling operations), this evaluation is particularly simple. This is explained further below on the basis of exemplary embodiments. However, the examples also illustrate to a person skilled in the art that an evaluation is likewise possible in the case of other progressions over time. The method according to the invention only reaches its limits when the simultaneous refuelling operations at the two filling points begin at virtually the same time and end at virtually the same time, which is extremely rare in practice. Should such a case actually occur, there would be the exceptional situation in which these two refuelling operations could not be assigned a gas flow.

A method analogous to the method according to the invention can also be used in principle in the case of filling pumps which have more than two filling points and in the case of which only one gas flow meter is available for more than two filling points.

For a given refuelling operation, the measured fuel flow can be compared with the assigned gas flow, for example in the form of the gas return rate/fuel delivery rate quotient (return rate ratio). Or, for a given refuelling operation, the measured volume of fuel is compared with the assigned volume of gas, which is determined by integration of the assigned gas flow over time. The values can therefore be further evaluated or used as though the gas flow had been measured directly for each filling point.

To carry out the method, each filling point may be assigned a gas pump of its own, or both filling points are assigned a common gas pump, which is arranged downstream of the meeting point of the gas streams of the two filling points.

The method according to the invention therefore makes it possible to operate the two gas returns of the filling points with a single gas flow meter in one filling pump. The saving of the costs for a gas flow meter can be higher than the additional expenditure for the evaluation of the measured values, which can generally be carried out in a control and monitoring device (for example a computer, if appropriate with additional electronics) that is present in any case in the filling pump. Furthermore, the method is suitable for retrofitting filling pumps that have only one gas flow meter.

In the case of overlapping refuelling operations, the gas return rates and also the returned volumes of gas can be registered separately for each filling point, and consequently meet for example the requirements laid down by authorities and dictated by environmental protection. The condition that a specific number of refuelling operations in succession must lie outside fixed tolerance limits can only be checked if this succession can also actually be evaluated. The method according to the invention allows such an evaluation for each refuelling operation near the time it occurs. With the known technique explained above, this was not possible.

In the case of a preferred refinement of the invention, the gas flow meter is designed as a thermal flow sensor. In the case of a thermal flow sensor, as described for example in DE 199 13 968 A, the gas flow is used for cooling a heated measuring sensor. Since the heat dissipation from the measuring sensor takes place by way of the mass flow of gas, i.e. the mass of gas flowing past the measuring sensor per unit of time, strictly speaking a thermal flow sensor does not measure a volumetric flow of gas but a mass flow of gas. It is precisely this, however, that is desired when monitoring a gas return system: the volumetric flow of gas at the inlet of the filling nozzle is to be registered. The gas temperature increases as a result of frictional losses in the gas pump and as a result of adiabatic compression, so that the volumetric flow of gas changes over the gas flow path in accordance with the gas equation. Furthermore, depending on flow resistance in the return system, the pressure increases, which likewise influences the volumetric flow of gas. Consequently, a flow sensor reacting to the volumetric flow of gas would produce incorrect measured values. The mass flow of gas on the other hand is not changed by the effects mentioned (continuity) and can be calculated back to the volumetric flow of gas at the inlet of the filling nozzle.

It has been found that an arrangement of a gas flow meter downstream of the gas pumps is subject to a strong influence by the pulsation of the gas pumps. Therefore, a pulsation damper (designed for example as a sound absorber/condensate trap) is preferably arranged in the gas flow path between the gas pump or the gas pumps and the gas flow meter to reduce the pulsation of the gas flow.

By means of one or more heat conductivity sensors in the gas flow path, information concerning the composition of the returned gas can be obtained, in particular on the proportion of air in a hydrocarbon mixture (see for example DE 199 13 968 A). This makes it possible when an ORVR vehicle (vehicle fitted with an activated carbon filter) is being refuelled to detect from the composition of the returned gases that the vehicle is an ORVR vehicle, from which essentially no hydrocarbon gas but only air gets into the gas return system. The gas return can then be stopped for this refuelling operation.

Since in the case of the method according to the invention the measured values obtained from the fuel flow meters are recorded, their variation over a long time can be used as information on the state of fuel filters of the fuel line system. If the fuel flow drops over time, this is a sign of deterioration of the fuel filters.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 shows a schematic view of a filling pump equipped according to the invention, with two filling points;

FIG. 2 shows a schematic view of a filling pump equipped according to the invention, with two filling points, in the case of which the gas return is additionally provided with a corrective control;

FIG. 3 shows a typical variation over time of the volumetric flow of fuel at a filling point for a number of refuelling operations, the breaks between the individual refuelling operations not being represented;

FIG. 4 shows an example of the variation over time of the volumetric flows of fuel at the two filling points of the filling pump and the common volumetric flow of gas in the case of partially overlapping refuelling operations; and

FIG. 5 shows an example of the variation over time of the volumetric flows of fuel at the two filling points of the filling pump and the common volumetric flow of gas in the case of completely overlapping refuelling operations.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

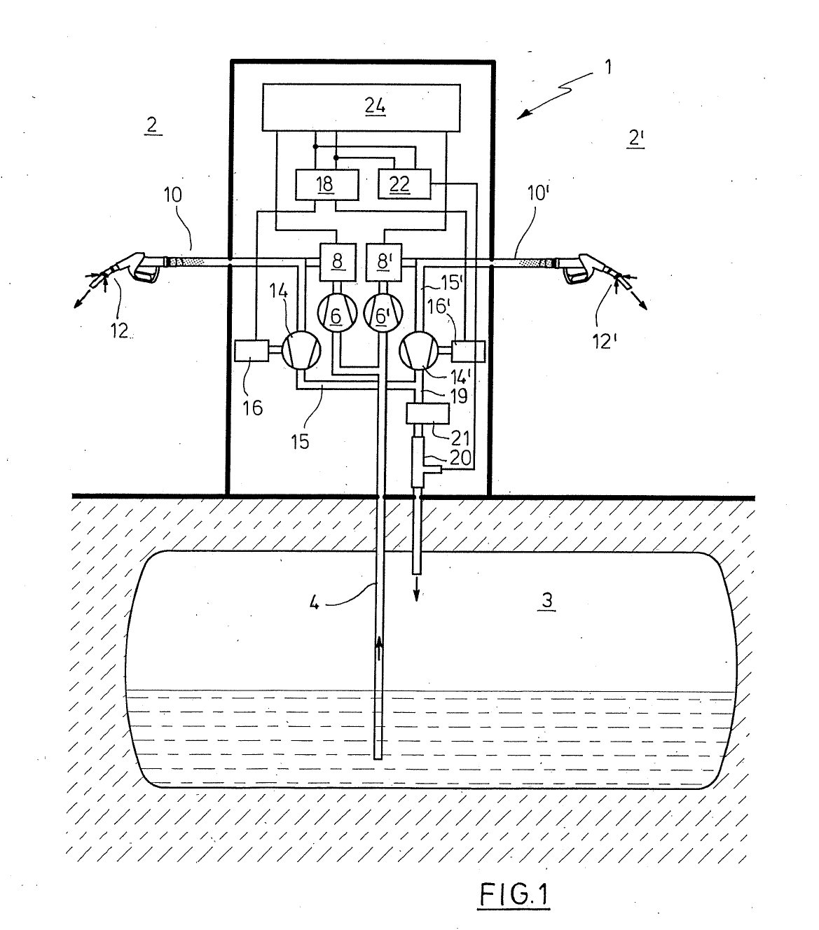

In FIG. 1, a filling pump 1 at a filling station is represented in a schematic way with the most important parts that are arranged in it or are assigned to the filling pump 1, including the components of a gas return system.

The filling pump 1 has two filling points, a first filling point 2 and a second filling point 2′, so that two vehicles can be refuelled simultaneously. The reference numerals of corresponding components for the filling point 2 and the filling point 2′ are the same apart from the prime mark. In the exemplary embodiment, carburettor fuel is refuelled at the filling points 2 and 2′. Further filling hoses may also be provided at the filling pump 1 for other grades of fuel.

While the filling pump 1 is in operation, fuel passes from an underground storage tank 3 via a fuel line 4, which branches to the two filling points 2 and 2′, and, delivered by a fuel pump 6 or 6′, passes through a fuel flow meter 8 or 8′ which serves for measuring the volumetric flow of fuel (and which emits counting pulses, the total number of counting pulses emitted in the course of a refuelling operation being a measure of the amount of fuel with which the tank is filled), and through a filling hose 10 or 10′ to a filling nozzle 12 or 12′, from which the fuel is filled into the tank of a motor vehicle, as indicated by the large arrows. (If the filling pump is designed for refuelling under pressure, the fuel pumps 6 and 6′ are no longer needed.) At the same time, the fuel vapours (gas) above the liquid fuel in the tank of the motor vehicle are extracted, which is indicated by the two small arrows at the respective filling nozzles 12 and 12′ of the first filling point 2 or of the second filling point 2′. These gases are taken in by a gas pump 14 or 14′, via a separate line made to run within the filling hose 10 or 10′, and pass through a gas line 15 or 15′ back into the storage tank 3. The gas pump 14 or 14′ is driven by a drive motor 16 or 16′. The drive motors 16 and 16′ are operated by means of driving circuits 18, since in the exemplary embodiment the gas flow is controlled by way of the rotational speed of the drive motor 16 or 16′.

At the location 19, the gas lines 15 and 15′ come together, so that the gas streams of the two filling points 2 and 2′ are made to meet. A single gas flow meter 20 serves for determining the total volumetric flow of gas of the two filling points 2 and 2′.

Arranged upstream of the gas flow meter 20 is a pulsation damper 21, which is designed in the form of a sound absorber/condensate trap, to reduce the pulsation of the gas flow.

In the case of gas return systems of the type explained, the volumetric flow of gas must be adapted to the volumetric flow of fuel. For this purpose, the signals (counting pulses) of the fuel flow meter 8 or 8′ are fed to a control and monitoring device, in order to drive the driving circuits 18 in such a way that the volumetric delivery rate (volumetric flow) of the gas pump 14 or 14′ coincides as far as possible with that of the fuel pump 6 or 6′.

In order that the monitoring system can react to errors in the gas delivery, the volumetric delivery rate of the gas pump 14 or 14′ (gas return rate) is monitored. For this purpose, a monitoring unit 22, which is connected to the filling-pump computer 24, is provided in the filling pump 1. The filling-pump computer 24 receives the signals from the fuel flow meter 8 or 8′ and passes them on to the monitoring unit 22, which is connected to the driving circuits 18. The monitoring unit 22 passes a signal characterizing the state of the gas return back to the filling-pump computer 24. In particular, in the event of a gas return error, this signal contains the alarm signals and the switch-off commands.

In the case of conventional systems, each filling point is provided with a gas flow meter of its own, the signals or measured values of which are passed to the monitoring unit, in order to compare the signals of the respective fuel flow meter and of the respective gas flow meter in the control and monitoring device, evaluate them and use them for assessing the gas return.

According to FIG. 1, however, the filling pump 1 has only one, common gas flow meter 20, the signals or measured values of which are passed to the monitoring unit 22, and are consequently available to the monitoring device 22. As explained below, the sum of the gas flow of the two filling points 2, 2′, measured by the gas flow meter 20, is broken down in the monitoring device 22 into a gas flow assigned to the first filling point 2 and a gas flow assigned to the second filling point 2′ (evaluation). These assigned gas flows can then be used to monitor the gas return for each filling point 2, 2′ individually in a conventional way.

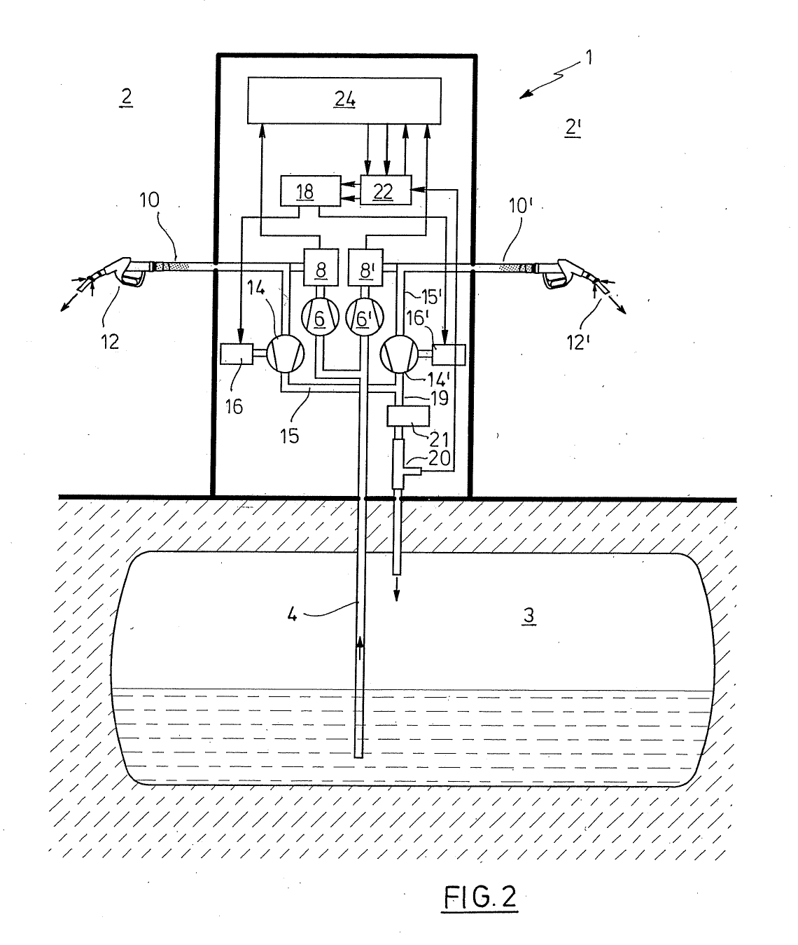

First, however, reference is to be made to FIG. 2, which likewise shows a filling pump with two filling points and a gas flow meter, but as a difference from the configuration according to FIG. 1 the gas return is additionally provided with a corrective control. The principle of corrective control is described in German Publication No. DE 103 37 800 A1, published Mar. 17, 2005, which is hereby incorporated by reference herein. Because of the great similarity of the arrangements according to FIG. 1 and FIG. 2, the same reference numerals are used in FIG. 1 and FIG. 2. In FIG. 2, the data flow for controlling the gas return is illustrated by arrow tips. As far as the integration of the gas flow meter 20 is concerned, this meter serving for monitoring the gas return for both filling points 2 and 2′, there is no difference between the arrangements according to FIG. 1 and FIG. 2. If the return rate ratio (determined in the way described further below) deviates from its setpoint value, the signals (counting pulses) of the fuel flow meter 8 or 8′ are modified in the corrective control to simulate a different volumetric flow of fuel to the driving circuits 18. On the basis of the (now erroneous) calibration data and the corresponding modified signals for the volumetric flow of the fuel, correct driving of the gas pumps 14 and 14′ is then obtained, so that the volumetric delivery rate (volumetric flow) of the gas pump 14 or 14′ again coincides as well as possible with that of the fuel pump 6 or 6′.

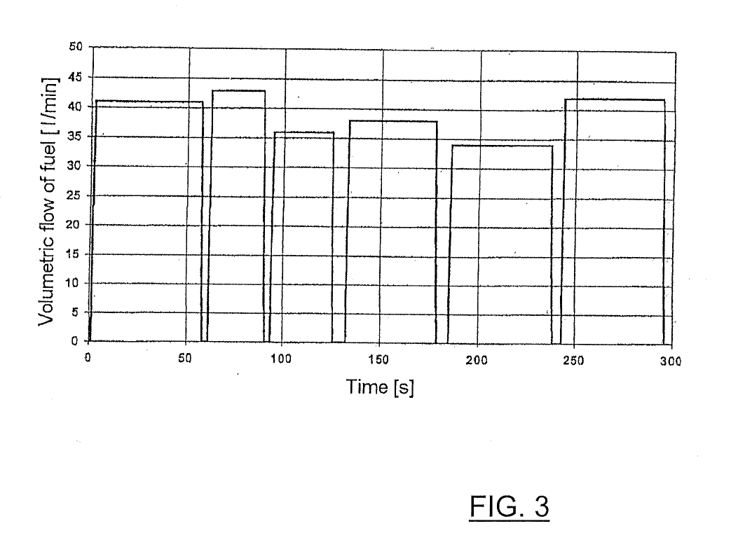

It will now be explained on the basis of FIGS. 3 to 5 how the gas return of the two filling points 2, 2′ can be monitored with the aid of the gas flow meter 20.

For refuelling operations that are actuated from different filling points 2, 2′ of the filling pump 1 and do not overlap in time, the evaluation is unproblematical, since the gas streams can be clearly assigned to the fuel flows.

In the evaluation of overlapping refuelling operations, use can be made of the fact that refuelling operations almost always take place by the filling nozzle being actuated after it has been inserted into the tank filler neck and the refuelling being performed with a virtually uniform volumetric flow of fuel (fuel flow). An example of such a refuelling sequence of a filling point is represented in FIG. 3. The instantaneous values of the fuel flow are respectively shown. The breaks between the refuelling operations are not represented. It is evident that the fuel flow is around 40 l/m. The variation over time of the fuel flow is largely box-shaped with very steep edges. If a filling point is equipped with a number of filling hoses (for different carburettor fuels), the fuel flows for the different filling hoses are usually different, for example because of different flow resistances of the fuel filters, which become clogged over time.

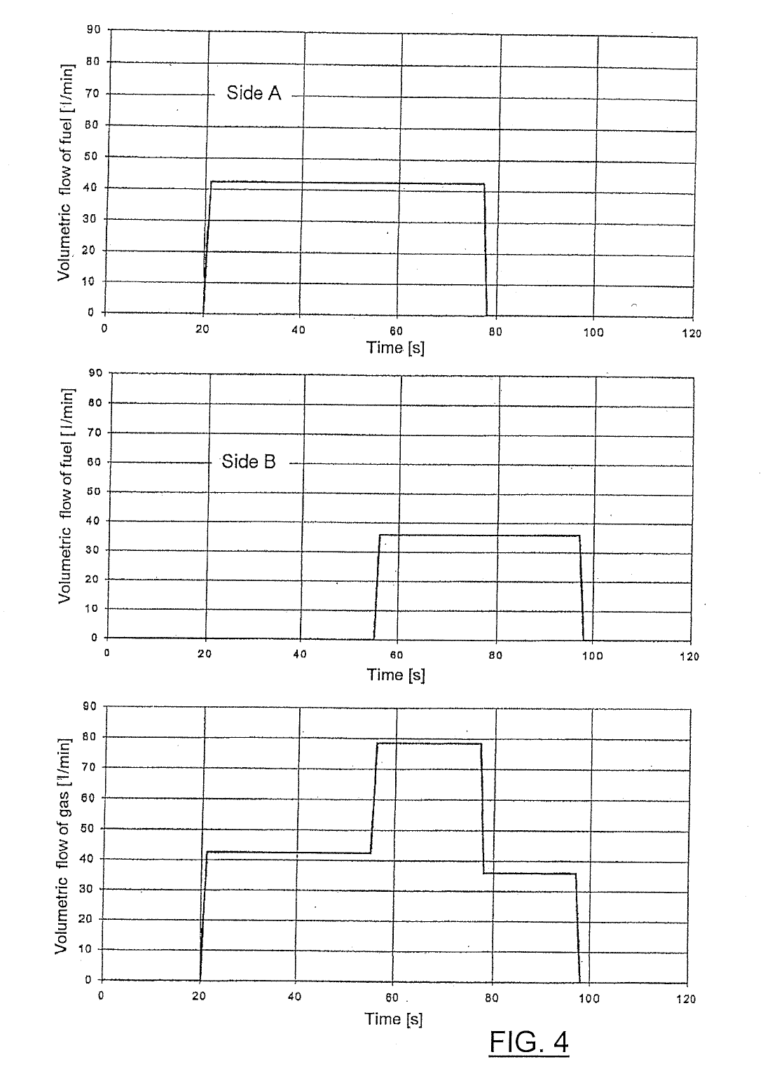

If refuelling is then performed simultaneously for a certain time on both sides of the filling pump, i.e. at the two filling points 2 and 2′ (according to FIG. 4 on side A and on side B), the gas flow for the gas return is cumulative for this time. An example of such an overlap in time is shown in FIG. 4. The overlap is virtually never 100%, since the refuelling operations do not begin or end at precisely the same point in time. In the example shown, it is evident that the refuelling operation on side A begins first and the associated gas flow can be determined directly, without being influenced by side B, by means of a gas flow meter 20. Consequently, the return rate ratio can be determined as a volumetric flow of gas/volumetric flow of fuel (i.e. gas flow/fuel flow) quotient for the refuelling operation on side A. The refuelling operation on side B begins later and lasts beyond the end of the refuelling operation on side A. In the period of time after completion of the refuelling operation on side A, the gas flow for side B can be determined, and consequently the return rate ratio for side B. In the period of direct overlap, the sum of the gas flows of side A and side B is measured. This value may likewise be evaluated at the same time and can serve for control purposes.

After completion of the two overlapping refuelling operations, the volumes of fuel used for refuelling are immediately known for both sides of the filling pump. The gas flows in the non-overlapping period and the time marks given by the variations over time of the fuel flows on sides A and B can be used to calculate the return volumes of gas on sides A and B by means of the relationship gas volume=gas flow*time. For the period of overlap, a virtual constant of the gas flows is assumed, which is virtually always the case in practice. This allows the return ratio to be determined as a gas volume/fuel volume of the respective refuelling operation, if this is prescribed.

To be able to carry out the evaluation explained, the variations over time that are shown in FIG. 4 must be available. For this purpose, the measured values obtained from the two fuel flow meters 8, 8′ and from the gas flow meter 20 are recorded at short predetermined time intervals, the recording times being assigned to one another. “Short” means here that the time intervals must be short in comparison with the typical duration of a refuelling operation, in order to obtain virtually continuous and informative curves, and as in FIG. 4. The measured values may also be recorded or stored as signals or in coded form. The data storage and evaluation take place in the monitoring device 22. In order for the described method to be carried out on an existing system, a new program, possibly supplemented by firmware or hardware components, is usually already sufficient for the conversion.

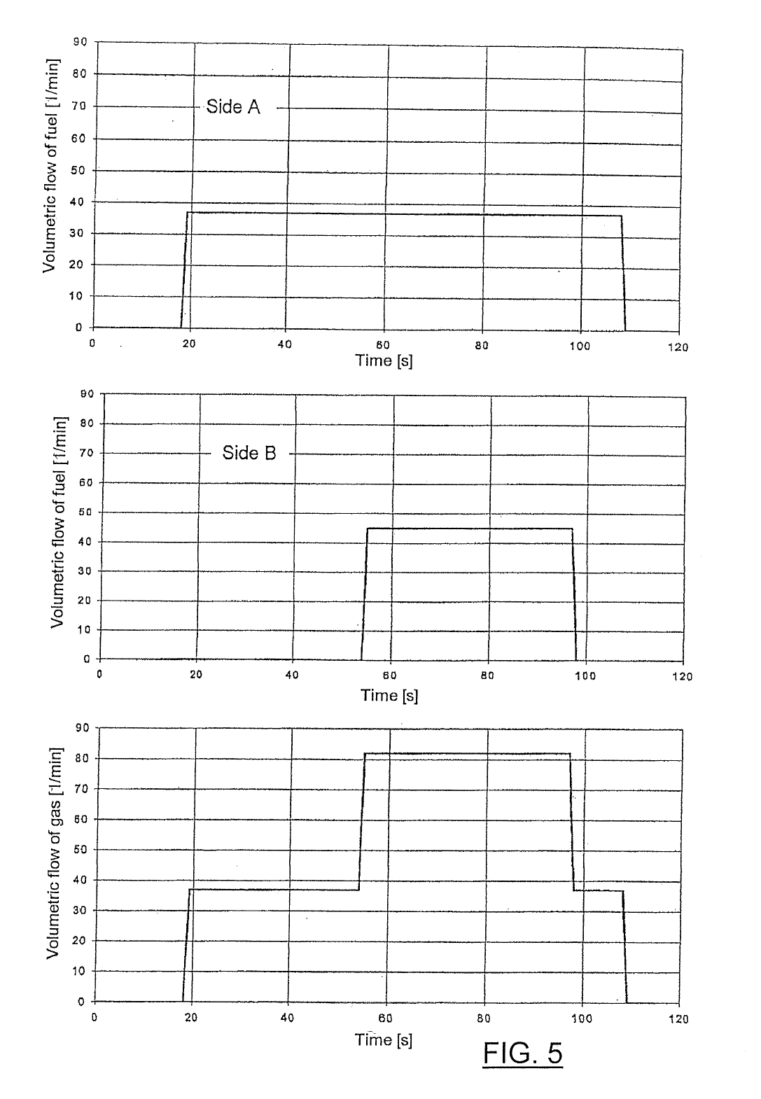

A further case is represented in FIG. 5. Here, a refuelling operation on side A likewise begins first, and the gas flow for this side can be determined. While this refuelling operation is still in progress, a refuelling operation on side B begins. This increases the measured gas flow by the additional gas flow from the gas return of side B. The refuelling operation of side B is completed earlier, however, and the gas flow drops again to the previous value of side A. As can be seen from the shape of the curve in the diagram, the gas flow of side B can be determined by subtraction of the previously determined gas flow of side A from the measured gas flow in the period of overlap. In this way, the return rate ratio for both the sides A and B can also be determined. The absolute returned volumes of gas can be calculated in a way analogous to the example according to FIG. 4.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A method of determining the gas return rate through a first filling point and a second filling point of a filling pump, with each filling point being assigned at least one fuel flow meter and the first and second filling points being assigned a common gas flow meter, which is arranged downstream of a meeting point of the gas streams of the first and second filling points, the method comprising the steps of:
(a) recording measured values obtained from the fuel flow meters and from the gas flow meter, wherein the values are recorded at short predetermined time intervals in fixed temporal relationship to one another; and
(b) in the case of at least partially simultaneous refueling operations at the first and second filling points, breaking down the measured sum of the gas flow of the first and second filling points into a first gas flow assigned to the first filling point and a second gas flow assigned to the second filling point,
step (b) including the step of using the measured values of the fuel flow meters to determine the time over which each of the at least partially simultaneous refueling operations occurs.

2. The method as claimed in claim 1,
step (b) including the steps of measuring the fuel flow through one of the filling points, and comparing the measured fuel flow with the assigned gas flow.

3. The method as claimed in claim 1;
(c) integrating one of the assigned gas flows to determine a measured volume of gas; and
(d) comparing a measured volume of fuel with the measured volume of gas.

4. The method as claimed in claim 1,
wherein any variation over time of the fuel flow and of the assigned gas flow is generally box-shaped.

5. The method as claimed in claim 1,
wherein each filling point is assigned a gas pump of its own.

6. The method as claimed in claim 1,
wherein the two filling points are assigned a common gas pump,
said common gas pump being arranged downstream of the meeting point of the gas streams of the two filling points.

7. The method as claimed in claim 1,
said gas flow meter being a thermal flow meter.

8. The method as claimed in claim 1,
wherein information concerning the composition of the returned gas is obtained by means of at least one heat conductivity sensor.

9. The method as claimed in claim 8;
(c) detecting from the composition of the returned gas that the vehicle is an ORVR vehicle; and
(d) stopping the gas return.

10. The method as claimed in claim 5; and
(c) reducing pulsation of the gas flow by at least one pulsation damper, which is arranged in the gas flow path between the gas pumps and the gas flow meter.

11. The method as claimed in claim 1; and
(c) monitoring any variation of the measured values obtained over a long time from the fuel flow meters to determine the state of fuel filters.

12. The method as claimed in claim 1; and
(c) compensating for any change of a return rate ratio using a corrective control.

13. The method as claimed in claim 1,
step (b) including the step of equating the first gas flow with a gas flow measurement taken when fuel is flowing only through the first filling point,
step (b) including the step of equating the second gas flow with another gas flow measurement taken when fuel is flowing only through the second filling point.

14. The method as claimed in claim 1,
step (b) including the step of equating the first gas flow with a gas flow measurement taken when fuel is flowing only through the first filling point,
step (b) including the step of calculating the second gas flow by subtracting the gas flow measurement from another gas flow measurement taken when fuel is flowing through the first and second filling points.

15. The method as claimed in claim 1,
wherein step (a) includes the step of taking fuel flow and gas flow measurements at predetermined time intervals about equal to or less than a second.

16. The method as claimed in claim 6; and
(c) reducing pulsation of the gas flow by at least one pulsation damper, which is arranged in the gas flow path between the gas pump and the gas flow meter.

17. The method as claimed in claim 2;
(c) integrating one of the assigned gas flows to determine a measured volume of gas; and
(d) comparing a measured volume of fuel with the measured volume of gas.

18. The method as claimed in claim 2,
wherein any variation over time of the fuel flow and of the assigned gas flow is generally box-shaped.

19. The method as claimed in claim 2,
wherein each filling point is assigned a gas pump of its own.

20. The method as claimed in claim 2,
wherein the two filling points are assigned a common gas pump,
said common gas pump being arranged downstream of the meeting point of the gas streams of the two filling points.

21. The method as claimed in claim 2,
said gas flow meter being a thermal flow meter.

22. The method as claimed in claim 2,
wherein information concerning the composition of the returned gas is obtained by means of at least one heat conductivity sensor.

23. The method as claimed in claim 19; and
(c) reducing pulsation of the gas flow by at least one pulsation damper, which is arranged in the gas flow path between the gas pumps and the gas flow meter.

24. The method as claimed in claim 20; and
(c) reducing pulsation of the gas flow by at least one pulsation damper, which is arranged in the gas flow path between the gas pump and the gas flow meter.

25. The method as claimed in claim 2; and
(c) monitoring any variation of the measured values obtained over a long time from the fuel flow meters to determine the state of fuel filters.

26. The method as claimed in claim 2; and
(c) compensating for any change of a return rate ratio using a corrective control.

27. The method as claimed in claim 2,
wherein step (a) includes the step of taking measurements at predetermined time intervals about equal to or less than a second.

28. The method as claimed in claim 3,
wherein step (a) includes the step of taking measurements at predetermined time intervals about equal to or less than a second.

29. A device for determining the gas return rate through a first filling point and a second filling point of a filling pump, with each filling point being assigned at least one fuel flow meter and both filling points being assigned a common gas flow meter, which is arranged downstream of a meeting point of the gas streams of the two filling points, said device comprising:
a computerized monitoring device operable to be in electronic communication with the flow meters,
said monitoring device being configured to
record the measured values obtained from the two fuel flow meters and from the gas flow meter, wherein the values are recorded at short predetermined time intervals in fixed temporal relationship to one another,
in the case of at least partially simultaneous refueling operations at the first and second filling points, break down the measured sum of the gas flow of the first and second filling points into a first gas flow assigned to the first filling point and a second gas flow assigned to the second filling point,
wherein the step of breaking down the measured sum of the gas flows includes the step of using the measured values of the fuel flow meters to determine the time over which each of the at least partially simultaneous refueling operations occurs.
